(19) United States
(12) Patent Application Publication
(10) Pub. No.: US 2022/0016798 A1
(43) Pub. Date: Jan. 20, 2022

(54) CUTTING MACHINE FOR PAPER ROLLS WITH A SHARPENING DEVICE

(71) Applicant: FUTURA S.P.A., Capannori (LU) (IT)

(72) Inventors: Ciro GUARINI, Pisa (IT); Gabriele BETTI, Capannori (IT); Andrea CATALINI, Porcari (IT); Giovacchino GIURLANI, Capannori (IT)

(73) Assignee: FUTURA S.P.A., Capannori (LU) (IT)

(21) Appl. No.: 17/441,848

(22) PCT Filed: May 22, 2020
(86) PCT No.: PCT/IT2020/050132

§ 371 Date: Sep. 22, 2021

(30) Foreign Application Priority Data
Jun. 10, 2019 (IT) 102019000008490

(51) Int. Cl. B26D 3/16; B26D 1/16; B24B 3/46; B26D 7/12

(52) U.S. Cl. CPC B26D 3/16; B26D 1/16; B26D 2210/11; B26D 7/12; B24B 3/46

(57) ABSTRACT

A cutting machine for the transversal cutting of logs of paper material, including a cutting unit, at least one sharpening unit with two grinding wheels and a device for positioning the grinding wheels. The device includes a primary carriage and two secondary carriages. The primary carriage has a surface arranged at a predetermined distance from the plane of the blade and forming a surface for controlling the run of the secondary carriages. In a first step of positioning the grinding wheels, the secondary carriages bring the abrasive side of the grinding wheels into contact with the surface. In a second step, the secondary carriages bring the abrasive side of the grinding wheels to the plane. In a third step, the primary actuators move the primary carriage until the abrasive side of the grinding wheels contacts the blade.

### DESCRIPTION

The present invention relates to a cutting machine and, more particularly, a cutting-off machine for the transversal cutting of logs of paper material.

It is known that rolls of toilet paper, kitchen paper and paper for similar uses are obtained by transversal cutting of rolls of greater length, commonly called “logs” and produced by machines called “rewinders” in which a predetermined amount of a web of paper material, consisting of one or more overlapping paper plies, is wrapped around itself, or around cardboard tubes called “cores”. Generally, the logs produced by the rewinders are conveyed to a buffer store and, from this, to machines, called “cutting-off machines” which perform the aforementioned transversal cut. Generally, the cutting machines have a platform on which are defined guide channels for logs and, downstream of said channels, a cutting unit which includes a disk blade suitably operated and moved to determine the transverse cutting of the logs with a programmed sequence depending on the length of the rolls that must be obtained from the logs. The blades are normally associated with grinding wheels which cyclically intervene to restore the cutting profile of the blades themselves. Periodically the blades of the cutting machines must be replaced due to wear which progressively reduces both the diameter and the cutting capacity. Whenever a worn blade is replaced with a new one, the position of the grinding wheels must be adjusted with respect to the blade.

EP3194128B1 describes a machine for the transversal cutting of logs of paper material comprising a feed path for the logs to be cut, a cutting unit with a replaceable discoid blade and supported so that it can rotate around its axis while it is subject to a cyclic movement for cutting the logs and to allow the advancement of the logs along the said feed path, and a sharpening unit with two grinding wheels configured and controlled to intervene on the discoid blade when the latter must be sharpened. The grinding wheels are mounted on a support system which includes a controlled approach mechanism of the grinding wheels to the blade configured to move each grinding wheel in a direction substantially parallel to its rotation axis. Said mechanism acts so as to bring a support slide of each grinding wheel to a nominal position with respect to the blade, and to approach the grinding wheel to the blade in a controlled manner by moving the grinding wheel with respect to the respective slide which is kept in said nominal position.

The main purpose of the present invention is to propose a logs cutting machine in which the positioning of the grinding wheels with respect to the blade replaced from time to time is automated and in which this positioning is substantially independent of the diameter of the blade, by means of a mechanically simple and programmable system so as to also allow independent position adjustments for the two grinding wheels.

A further object of the present invention is to propose a machine for cutting logs in which the positioning system of the grinding wheels on the blade integrates a mechanism for detecting the degree of wear of the grinding wheels in order to always obtain the most correct execution of the cut.

This result has been achieved, in accordance with the present invention, by adopting the idea of making a machine having the characteristics indicated in claim 1. Other features of the present invention are the subject of the dependent claims.

Thanks to the present invention, it is possible to position the grinding wheels automatically, in less time than the positioning performed manually and with greater operational safety since this operation does not require operators access to the area of the machine that houses the blade. Furthermore, a device for positioning the grinding wheels in a machine according to the present invention has a relatively simple structure and integrates an effective mechanism for recognizing the desired position for the wheels. Further advantages are linked to the possibility of independently controlling the positions of the grinding wheels when they are approached to the blade to be sharpened.

These and further advantages and characteristics of the present invention will be more and better evident to each person skilled in the art thanks to the description that follows and the annexed drawings, provided by way of example but not to be considered in a limiting sense, in which:

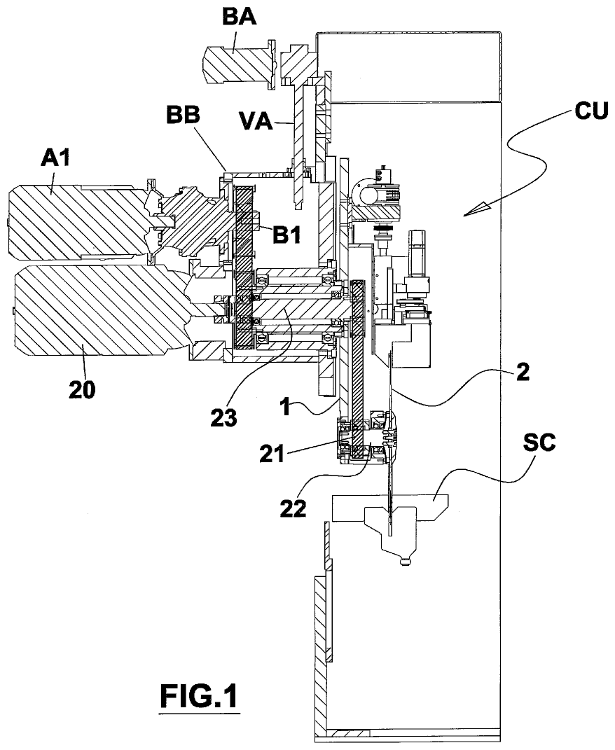

FIG. 1 is a schematic vertical section view of the cutting station of cutting machine for the transversal cutting of logs of paper material with a cutting unit in accordance with the present invention;

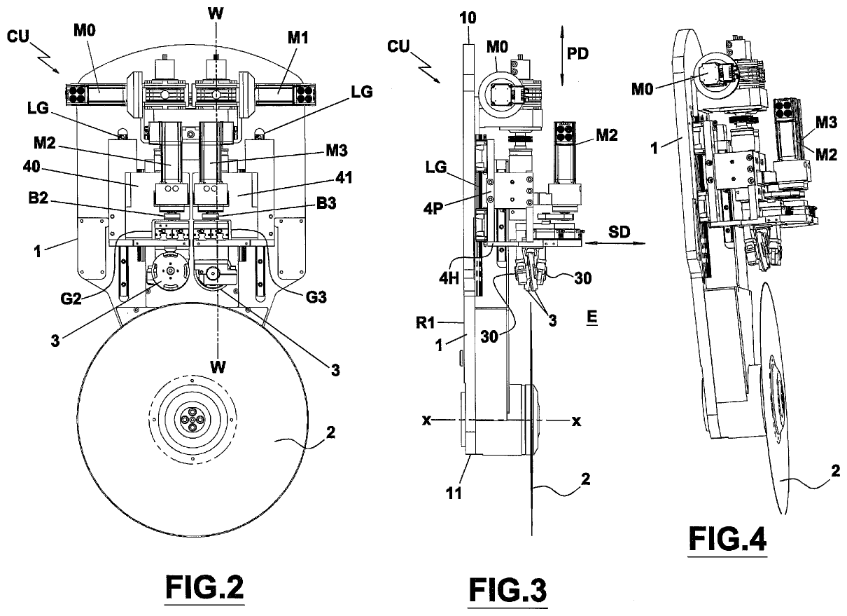

FIG. 2 is a schematic front view of a cutting unit for cutting machines in accordance with the present invention;

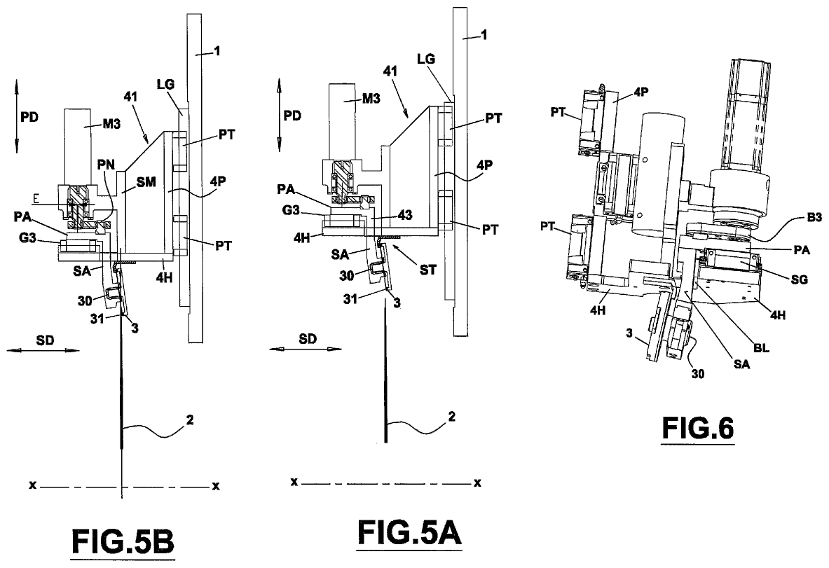

FIG. 3 is a schematic side view of the cutting unit of FIG. 2;

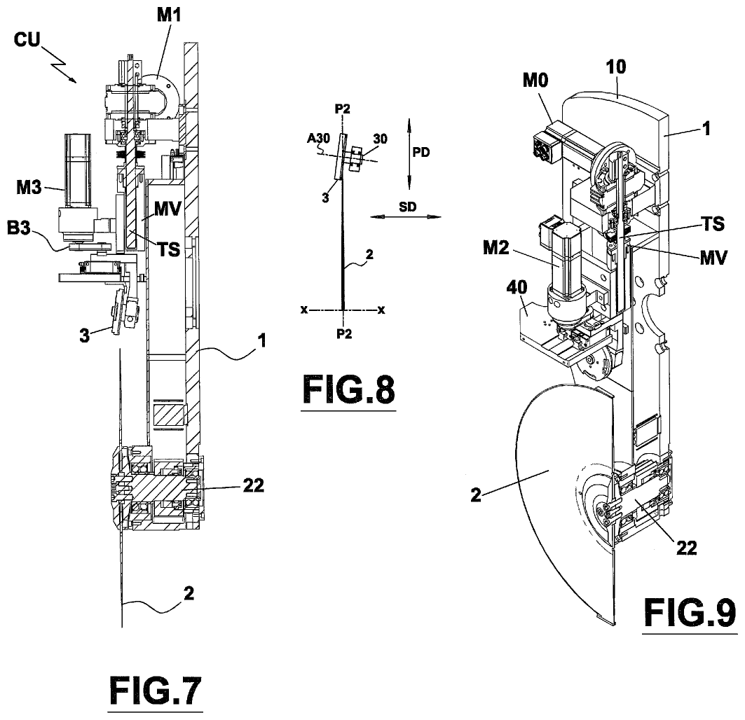

FIG. 4 is a schematic perspective view of the cutting unit shown in FIG. 2 and FIG. 3;

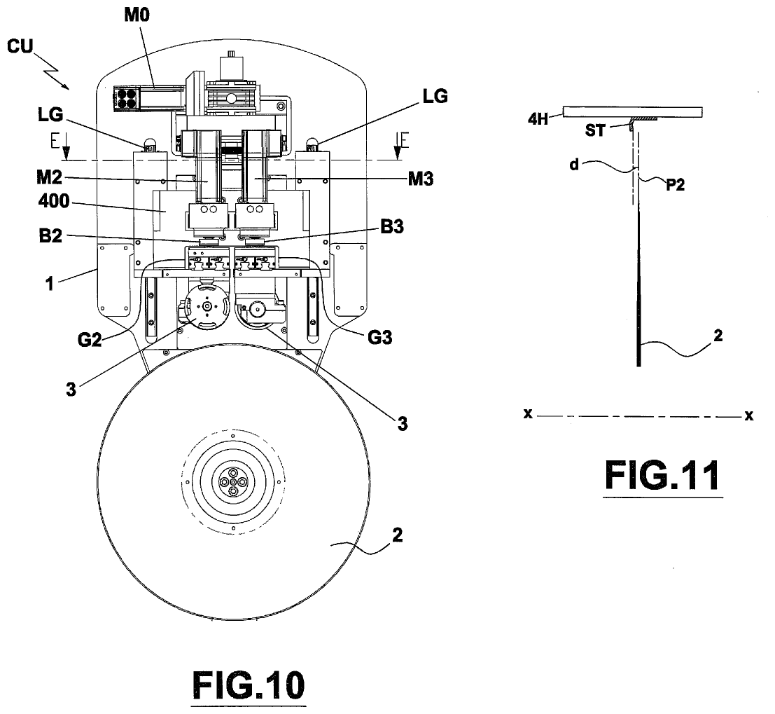

FIG. 5A is a section view according to line W-W of FIG. 2;

FIG. 5B is similar to FIG. 5A but shows the cutting unit with a grinding wheel in blade sharpening position;

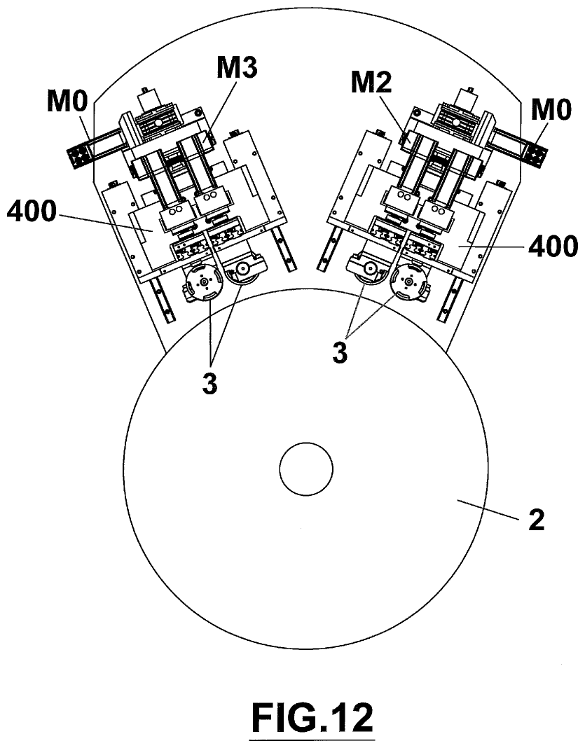

FIG. 6 is a further perspective view of a cutting unit for cutting machines in accordance with the present invention, in which the blade is not shown to better highlight other parts of the same unit;

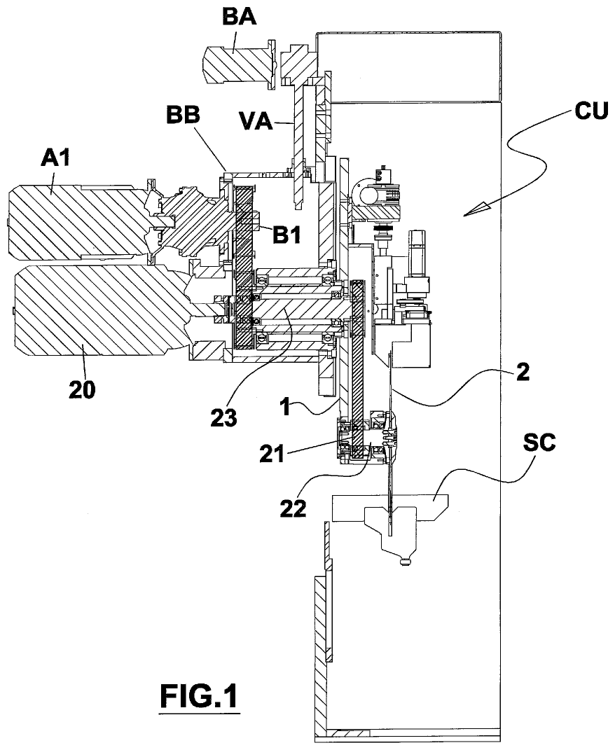

FIG. 7 is a schematic vertical sectional view of a cutting unit for cutting machines according to the present invention, in which the blade is not shown;

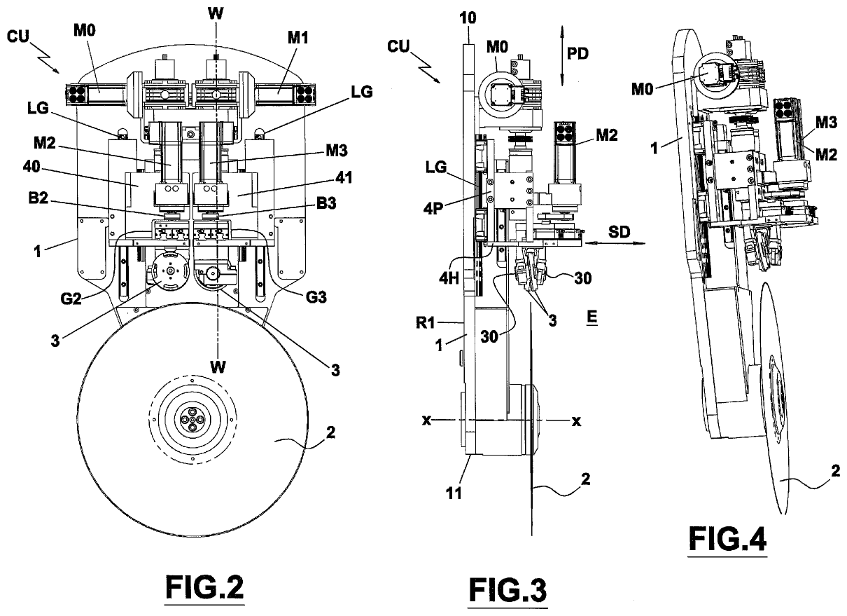

FIG. 8 is a diagram illustrating a possible orientation of a grinding wheel with respect to the plane (P2) of the blade (2);

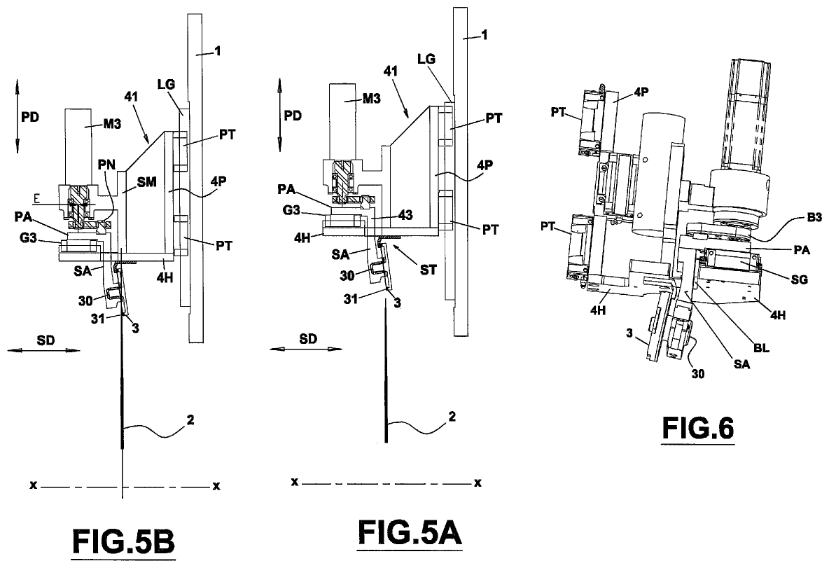

FIG. 9 is a sectional perspective view of a cutting unit according to the invention;

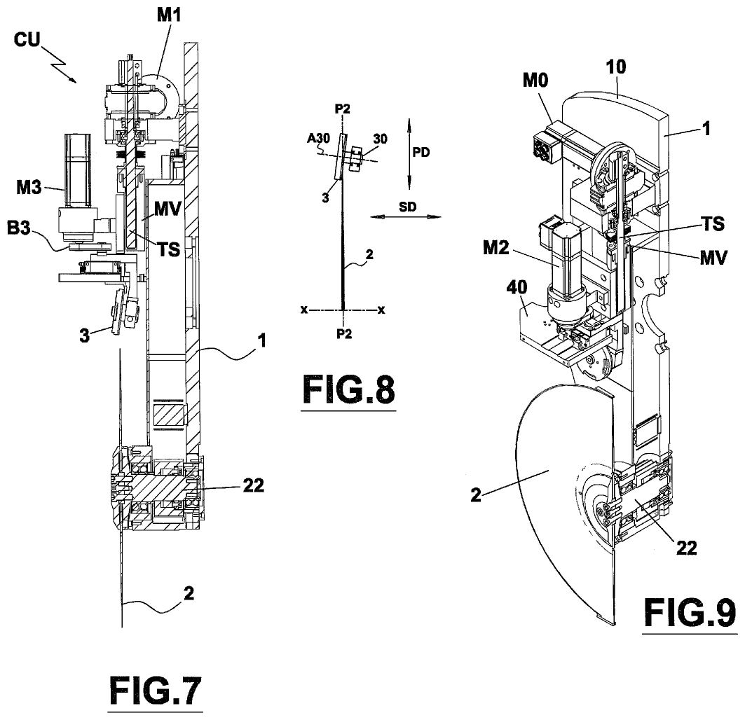

FIG. 10 is a front view of a cutting unit according to the present invention in which the primary carriage is made up of a single element;

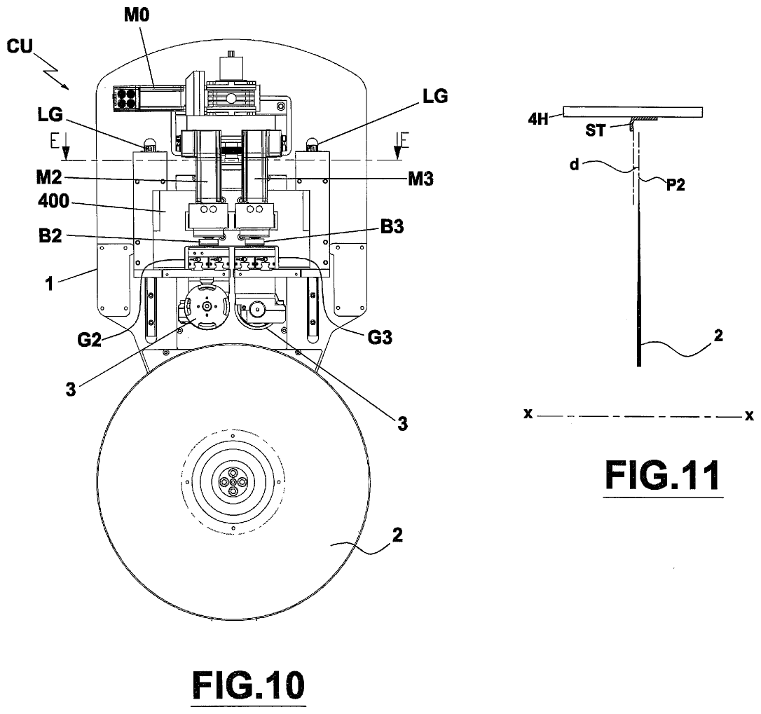

FIG. 11 is a representation of the position of a surface (ST) with respect to the plane (P2) of the blade;

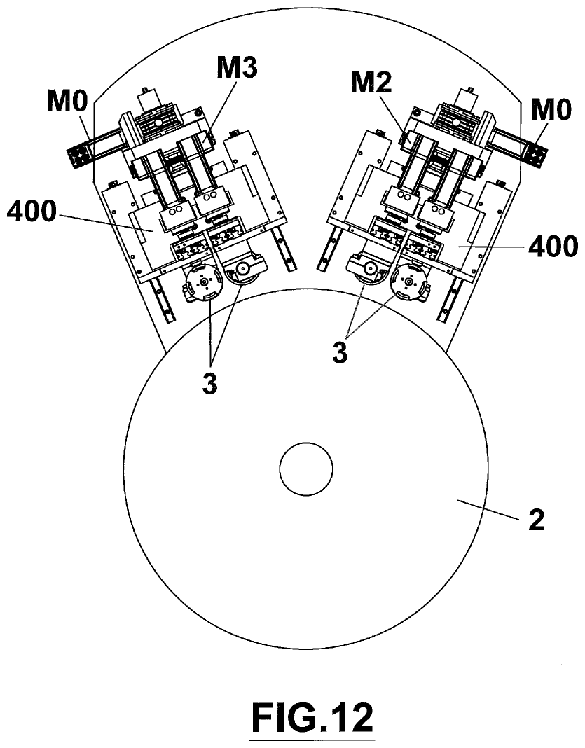

FIG. 12 schematically show a further embodiment of the present invention. Reduced to its essential structure and with reference to FIGS. 1-11 of the attached drawings, a cutting machine to which a cutting unit according to the present invention is applicable is of the type comprising:

a structure (SC) on which the logs to be cut transversely are moved in order to obtain rolls of shorter length;
a cutting unit (CU) arranged in a predetermined point of said structure (SC) and comprising a support plate (1) for a blade (2) which can be removably connected to a respective rotary actuator (20) arranged at one end of said plate (1) and apt to determine the rotation of the blade itself around its own axis (xx) with predetermined speed, said plate (1) being in turn constrained to a further actuator which drags it into rotation with predetermined angular speed around an axis parallel to the rotation axis (x-x) of the blade (2);
a sharpening unit with two grinding wheels (3) suitably provided to perform the sharpening of the blade (2);
a device for positioning said grinding wheels (3) with respect to the blade (2).

FIG. 1 schematically shows the main elements of a cutting machine (CM) in which a cutting unit can be mounted in accordance with the present invention, it being understood that the drawing is provided only to show the position of the cutting unit with respect to the path of the logs. It is also understood that the cutting machine can be made in any suitable way providing the transversal cutting of logs of paper material, to obtain rolls of shorter length, by means of a cutting unit comprising a blade which acts transversely to the logs themselves.

In the example of FIG. 1, in accordance with a construction scheme known per se, the actuator (20) is connected to the blade (2) by means of a belt (21) which connects the central pin (22) of the same blade to the shaft (23) of the actuator (20) through a pulley arranged on the free end of such shaft (23). Furthermore, the plate (1) is rotated, around an axis parallel to the axis of rotation of the blade (2), by means of a corresponding rotary actuator (Al) with shaft (B1) parallel to the shaft (23) of the actuator controlling the rotation of the blade (2). The actuator (20), which for example is an electric motor, is solid with a box-shaped body (BB) located above said structure (SC) and inside which the belt (21) and the shafts (23) and (B1) are arranged. Said body (BB) is connected to a corresponding actuator (BA) which, through a screw (VA) acting on a nut screw bush arranged on an upper side of the same body (BB), controls its vertical position, i.e. its positioning with respect to the underlying structure (SC). Consequently, by controlling the position of the body (BB), the blade (2) can be positioned at the desired height. The actuator (Al), which for example consists of an electric motor, is also solid with the body (BB).

In practice, the blade (2) rotates around a respective axis (x-x) which is parallel to the axis of rotation of the plate (1).

With reference to FIGS. 2-8 of the attached drawings, a cutting unit (CU) according to the present invention comprises a plate (1) with an upper side (10), a lower side (11), a front side (F1) and a rear side (R1). On the lower side (11) of the plate (1) is mounted the central pin (22) of a circular blade (2) which is removably applied on this pin in order to allow its replacement when necessary. The blade (2) is oriented parallel to the plate (1) and is positioned at a predetermined distance from the front side(F1) of the latter. On the plate (1) there are also mounted two grinding wheels (3) designed to sharpen the blade (2) and a device for positioning said grinding wheels (3) with respect to the blade (2). Each grinding wheel (3) is applied on a respective support shaft (30) whose axis (A30) has an inclination of predetermined value with respect to the front side (F1) of the plate (1) and, consequently, with respect to a corresponding surface of the blade (2). In the diagram of FIG. 9 the shaft (30) supporting a grinding wheel (3), the respective axis (A30), the inclination of this grinding wheel (3) in sharpening position with respect to a surface (A2) of the blade (2) and the plane (P2-P2) of the latter are particularly visible.

In accordance with the present invention, the aforementioned positioning device for the grinding wheel (3) comprises:
a primary carriage (4) movable parallel to the plate (1) according to a primary movement direction (PD);
two secondary carriages (42, 43) connected to the primary carriage (4) and individually movable according to a secondary movement direction (SD) orthogonal to said primary movement direction (PD), each secondary carriage (42, 43) exhibiting a seat for supporting the shaft (30) of a corresponding grinding wheel (3);
a limit stop (ST) apt to limit the stroke of each secondary carriage (42, 43) along said secondary direction (SD).

In practice, the primary direction of movement (PD) is a direction parallel to the plane (P2) of the blade (2), i.e. a radial direction with respect to the latter, while the secondary direction of movement (SD) is a direction parallel to the rotation axis (x-x) of the blade (2).

The primary carriage (4) can consist of two independent units (40, 41) to each of which a corresponding secondary carriage (42, 43) is attached. Alternatively, the primary carriage can consist of a single unit (400) on which both the secondary carriages (42, 43) are connected.

With reference to the embodiment shown in FIGS. 2-9, the primary carriage (4) is made up of two independent units each of which consists of a body (40, 41) connected to the internal side (F1) of the plate (1) by means of a linear guide (LG) which allows it to be guided along the primary movement direction (PD). The sliding of each body (40, 41) along the primary movement direction (PD) is controlled by a corresponding electric motor (MO, M1). Each motor (MO, M1) is fixed on the internal side (F1) of the plate (1) and drives a threaded shaft (TS) which engages a corresponding nut bushing (MV) formed on each body (40, 41). Therefore, each body (40, 41) can be moved independently by the respective motor (MO, M1) along the primary direction of movement (PD).

Each of said bodies (40, 41) has a first side (4P) parallel to the internal side (F1) of the plate (1) and a second side (4H) orthogonal and underlying the first side (4P). The first side (4P) slides along the respective guide (LG). The second side (4H) constitutes a cantilever structure whose function is disclosed below. In practice, each of said bodies (40, 41), seen laterally, has a structure with a part (4P) parallel to the internal side (Fl) of the plate (1) and a part (4H) orthogonal to the same internal side (F1) of the plate (1) and oriented towards the outside (E) so as to define a bracket above the blade (2). In the example described above, the movement of the bodies (40, 41), i.e. of the two units that make up the primary carriage (4), is a guided movement thanks to the presence of the guides (LG) that constrain the bodies (40, 41) to the internal side (F1) of the plate (1). The “PT” references denote two pads arranged at a predetermined distance from each other on the side (4P) of each body (40, 41) and intended to slide on said guides (LG).

Each of the secondary carriages (42, 43) has a first arm (PA) parallel to the bracket (4H) of the respective primary carriage, to which it is connected by means of a corresponding slide guide (G2, G3), and a second arm (SA) which is orthogonal to the first arm (PA) and, at its free end, supports the shaft (30) of a respective grinding wheel (3). The second arm (SA) passes through a hole (BL) formed in the bracket (4H), so that the grinding wheel (3) with the relative shaft (30) is below the bracket (4H) and that said second arm (SA) is free to move in the hole (BL) according to the direction of secondary movement (SD). On the first arm (PA) of each secondary carriage (42, 43) a connecting rod (B2, B3) is connected which, in turn, is enslaved to a corresponding electric motor (M2, M3). Each motor (M2, M3) is supported by a surface (SM) that each primary carriage (40, 41) has at a predetermined distance from its side (4P) parallel to the plate (1). Each connecting rod is connected to the first arm (PA) by means of a pin (PN) orthogonal to both the connecting rod and the first arm. Therefore, each motor (M2, M3) can move the respective secondary carriage (42, 43) according to the direction of secondary movement (SD). This movement is a guided movement since each secondary carriage is connected to the primary carriage by means of a respective slide (G2, G3) which, in fact, is oriented according to the direction (SD).

Thus, each grinding wheel (3) is supported by the cutting unit (CU) in such a way that it can be moved both according to the primary direction of movement (PD) and according to the secondary direction of movement (SD). In fact, the bodies (40, 41) of the primary carriage (4) can be moved according to the direction (PD) by means of the motors (MO, M1), while the secondary carriages (42, 43) can be moved on the primary carriage along the direction (SD) by means of the motors (M2, M3).

The grinding wheels (3) are oriented with the respective grinding surfaces (31) towards the plane (P2) of the blade (2).

The cutting unit has also an abutment surface (ST) which acts as an end stop for the secondary carriages (42, 43) as further described below.

For example, said abutment surface is defined by a plate with a side fixed to the horizontal part (4H) of the primary carriage and a side (ST) protruding downwards, i.e. towards the blade (2).

The side (ST) projecting downwards defines the abutment surface. The surface (ST) is at a predetermined position with respect to the lying plane (P2) of the blade (2). More particularly, the surface (ST) is at a predetermined distance (d) from the plane (P2) of the blade (2) whose position is known. For example, the surface (ST) is at a distance of 0.5 mm from the plane (P2). FIG. 11 is a diagram in which the aforementioned distance “d” is represented. It goes without saying that, since the grinding wheels (3) are on opposite sides with respect to the plane (P2), their movements along the direction (SD) are opposite.

One possible mode of operation of the device described above is the following. When a new blade is mounted on the cutting unit (CU), in a first phase of adjusting the position of the grinding wheels, the secondary carriages (42, 43) starting from a predetermined initial position, are moved along the direction (SD) by the motors (M2, M3) so that each grinding wheel (3) is brought with its respective surface (31) in contact with the surface (ST). The motors (M2, M3) detect a torque variation when the grinding wheels (3) come into contact with the surface (ST) and, in this phase, stop the movement of the grinding wheels whose position along the direction (SD), therefore, is defined by the contact with the surface (ST). At this point, the stroke of each secondary carriage (42, 43) is detected, i.e. the run of each secondary carriage (42, 43) is detected starting from the initial position up to the position of contact of the grinding wheels (3) with the surface (ST). This detection allows to estimate the degree of wear of the abrasive side (31) of each grinding wheel because the run of each secondary carriage (42, 43) directed towards the surface (ST) increases when the wear of the respective grinding wheel (3) increases. Said detection is performed by an encoder associated with each of the motors (M2, M3) driving the secondary carriages (42, 43). Subsequently, each grinding wheel (3) is moved in the opposite direction to that which has determined its contact with the surface (ST), causing them to run for a distance value equal to the aforementioned distance (d). In this way, the surface (31) of each grinding wheel (3) is brought in correspondence of the plane (P2) regardless of the state of wear of the surface itself. Then, the primary carriage is moved along the direction (PD), until the grinding wheels (3) come into contact with the blade (2) which is made to rotate around its axis (x-x). This contact is detected through the same blade (2) which, in fact, undergoes a slowdown as a consequence of the contact itself. Normally the motor (20) that operates the blade is controlled by a system equipped with a control function that guarantees a constant rotation speed of the blade around the axis (x-x) during the transverse cutting of the logs. When the grinding wheel positioning device is in operation, so that the grinding wheels are moved first along the direction (SD) and then along the direction (PD) as mentioned above, the aforementioned motor control function (20) is temporarily deactivated. The contact of the wheels (3) with the blade (2) causes the latter to slow down and this condition is taken as an indicator of the contact between the grinding wheels and the blade. When this condition occurs, the run of the primary carriage in the direction (PD) is interrupted. In practice, the run of the primary carriage is interrupted when the grinding wheels (3) come into contact with the blade (2). Therefore, the grinding wheels (3) are always correctly positioned on the blade (2) regardless of the state of wear of the blade itself.

As previously mentioned, the primary carriage can consist of a single unit (400), instead of two independent units. In this case, as shown in FIG. 10, only one motor (MO) is provided for handling the single unit (400).

In relation to what has been previously described, a cutting-off machine for the transversal cutting of logs in accordance with the present invention comprises
a structure (SC) on which are moved the logs to be cut transversely in order to obtain rolls of shorter length;
a cutting unit (CU) arranged at a predetermined point of said structure (SC) and comprising a support plate (1) for a blade (2) removably connectable to a respective rotary actuator (20) adapted to determine the rotation of the same blade about its own axis (x-x) with a predetermined speed, said plate (1) being in turn constrained to a further actuator which drags it into rotation with a predetermined angular speed about an axis parallel to the axis (x-x) of rotation of the blade (2), the blade (2) being arranged along a lying plane (P2) perpendicular to said rotation axis (x-x) in a predetermined position within the cutting unit (CU);
at least one sharpening unit with two grinding wheels (3) suitably arranged to sharpen the blade (2) on opposite sides with respect to said plane (P2) and provided with an abrasive side (31);
a device for positioning said grinding wheels (3) with respect to the blade (2) arranged on each sharpening unit, by means of which each grinding wheel (3) is placed in a position of contact with the blade (2) in a sharpening step of the latter starting from an initial inoperative position;

wherein

said positioning device comprises a primary carriage (40, 41; 400) which can be moved along a primary direction (PD) radially with respect to the blade (2) by means of one or more primary actuators (MO, M1), and two secondary carriages (42, 43) each of which supports a a grinding wheel (3) and is supported by the primary carriage (40, 41; 400) and can be moved along a secondary direction (SD) parallel to the axis of rotation of the blade (2) by means of two secondary actuators (M2, M3);

the primary carriage (40, 41; 400) is provided with a surface (ST) arranged at a predetermined distance (d) from the plane (P2) of the blade (2), said surface (ST) being a control surface of the run of the secondary carriages (42, 43) along the secondary direction (SD);
in a first step of positioning the grinding wheels (3), the secondary actuators (M2, M3) move the secondary carriages so as to bring the abrasive side of the grinding wheels (3) into contact with said surface (ST);
in a second step of positioning the grinding wheels (3), the secondary actuators (M2, M3) move the secondary carriages so as to bring the abrasive side of the grinding wheels (3) in correspondence with the plane (P2) with a run of a value equal to the said distance (d) and directed in the opposite direction relative to the run of contact with the surface (ST);
in a third step of positioning the grinding wheels (3), said one or more primary actuators (MO, M1) to move the primary carriage (40, 41; 400) along the primary direction (PD) up to the contact of the abrasive side of the wheels (3) with the blade (2).

As said above, the grinding wheel positioning device can be configured so as to integrate within it a mechanism for detecting the state of wear of the grinding wheels. From this possibility derives the advantage of having an estimate of the degree of wear of the grinding wheels, with the possibility, therefore, to signal to the users of the machine the need to arrange the change of the grinding wheels when the estimated value of the degree of wear is greater than a pre-established limit. For this purpose, the mechanism for detecting the state of wear of the grinding wheels can be associated with an acoustic and/or visual indicator that alerts the users. Further advantages deriving from the integration of a grinding wheel wear detection mechanism are connected to the fact that in this way the blade will always be correctly sharpened, as it will be possible to avoid prolonged use of excessively worn grinding wheels and thus always ensure the correct transverse cutting of logs. Another advantage offered by the provision of a mechanism for detecting the degree of wear of the grinding wheels integrated in the positioning device of the same lies in the fact that the use of the machine is facilitated even for operators who are not particularly expert since the replacement of the grinding wheels is no longer closely linked to the experience of the operators. In addition, there is the fact that the detection on the degree of wear of the grinding wheels can form a database of values that can be used for statistical purposes both to record the actual use of each grinding wheel according to the conditions of use, and for a predictive program of replacements of the grinding wheels. With reference to the example shown in FIG. 12, the cutting machine can also be equipped with two sharpening units of the type described above. In this case, the two sharpening units are placed in different positions with respect to the blade (2) to act each on a different area of the blade. This can be useful in the case of large diameter circular blades, or circular blades with bevels of differentiated shape along the radius, so that each sharpening unit can act on a corresponding area of the blade. In the example of FIG. 12 each sharpening unit is identical to the one described above, so the description is omitted.

In practice, the details of execution can however vary in an equivalent way as regards the individual elements described and illustrated without thereby abandoning the idea of the solution adopted and therefore remaining within the limits of the protection granted by this patent in accordance with the following claims.

1-8. (canceled)

9. A cutting machine for the transversal cutting of paper material logs, comprising:
a structure on which are moved the logs to be cut transversely in order to obtain rolls of shorter length;
a cutting unit arranged at a predetermined point of said structure and comprising a support plate for a blade removably connectable to a respective rotary actuator adapted to determine the rotation of the same blade about its own axis (with a predetermined speed, said plate being in turn constrained to a further actuator which drags it into rotation with a predetermined angular speed about an axis parallel to the axis of rotation of the blade, the blade being arranged along a lying plane perpendicular to said rotation axis in a predetermined position within the cutting unit;
at least one sharpening unit with two grinding wheels suitably arranged to sharpen the blade on opposite sides with respect to said plane and provided with an abrasive side;
a device for positioning said grinding wheels with respect to the blade arranged on each sharpening unit, by means of which each grinding wheel is placed in a position of contact with the blade in a sharpening step of the latter starting from an initial inoperative position; wherein
said positioning device comprises a primary carriage which can be moved along a primary direction radially with respect to the blade by one or more primary actuators, and two secondary carriages each of which supports a a grinding wheel and is supported by the primary carriage and can be moved along a secondary direction parallel to the axis of rotation of the blade by two secondary actuators;
the primary carriage is provided with a surface arranged at a predetermined distance from the plane of the blade, said surface being a control surface of the run of the secondary carriages along the secondary direction;
in a first step of positioning the grinding wheels, the secondary actuators move the secondary carriages so as to bring the abrasive side of the grinding wheels into contact with said surface;
in a second step of positioning the grinding wheels, the secondary actuators move the secondary carriages so as to bring the abrasive side of the grinding wheels in correspondence with the plane with a run of a value equal to the said distance and directed in the opposite direction relative to the run of contact with the surface;
in a third step of positioning the grinding wheels, said one or more primary actuators to move the primary carriage along the primary direction up to the contact of the abrasive side of the wheels with the blade.

10. The cutting machine according to claim 9, wherein the primary carriage comprises two independent units.

11. The cutting machine according to claim 9, wherein the primary carriage is comprises a single unit.

12. The cutting machine according to claim 9, wherein the primary carriage is constrained to an inner side of the plate by a linear guide which allows its guided sliding along the primary direction.

13. The cutting machine according to claim 10, wherein each of said units comprises a body with a first side parallel to the inner side of the plate and a second side orthogonal and underlying the first side, wherein the first side slides along the respective guide, the second side is orthogonal to the inner side of the plate and is oriented towards the outside so as to define a shelf above the blade; and each of the secondary carriages has a first arm parallel to the bracket of the respective primary carriage, to which it is constrained by a corresponding slide guide, and a second arm which is orthogonal to the first arm and, at its free end, supports the shaft of a respective grinding wheel, the second arm passing through a slot formed in the bracket, so that the grinding wheel with the relative shaft are below the bracket and the said second arm is free to move in the slot according to the secondary movement direction, on the first arm (PA) of each secondary carriage being connected a connecting rod which, in turn, is slaved to a corresponding electric motor, each motor being supported by a surface that each of said bodies has at a predetermined distance from its side parallel to the plate, each connecting rod being connected to the first arm by a pin perpendicular to both the connecting rod and the first arm.

14. The cutting machine according to claim 9, wherein said grinding wheels positioning device is provided with a mechanism for detecting the wear of the grinding wheels.

15. The cutting machine according to claim 9, wherein the contact between the abrasive side of the grinding wheels and the control surface is detected through the detection of a torque variation on said secondary actuators which consist of electric motors.

16. The cutting machine according to claim 9, wherein the contact between the abrasive side of the grinding wheels and the blade is detected by detecting a slowing down of the latter.
